(19) United States
(12) Patent Application Publication
(10) Pub. No.: US 2009/0063182 A1
(43) Pub. Date: Mar. 5, 2009

(54) Method and apparatus for reconnecting individuals via a visual signal

(76) Inventors: Peter James Metz, Ann Arbor, MI (US); Nadav Baron, Ann Arbor, MI (US)

Correspondence Address: Peter Metz, 2527 Keystone Ln., Ann Arbor, MI, 48103, US

(21) Appl. No.: 12/231,277

(22) Filed: Sep. 2, 2008

Related U.S. Application Data
(60) Provisional application No. 60/970,255, filed on Sep. 5, 2007.

(51) Int. Cl. G06Q 10/00

(52) U.S. Cl. 705/1

(57) ABSTRACT

The present invention provides a system for reconnecting individuals via a visual signal. The visual signal is used by a certain individual to indicate to another individual of interest to correspond with them at a certain pre-determined destination such as a business location or on-line via a computer network, such as the Internet or a destination website. Sending a visual signal to another individual indicates that a certain individual is interested in corresponding with the other individual for dating, friendship, or other social or professional networking.

### CROSS-REFERENCE TO RELATED APPLICATIONS

This patent application is based on a prior provisional patent application submitted on Sep. 5, 2008.

Application No.: 60970255

EFS ID: 2162754

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

Most people at one time or another have made eye contact or have engaged in conversation with others, and later regretted not taking the initiative to exchange contact information so that they could correspond with that individual at another time. An example of such correspondence could be dating, friendship, or other social or professional networking. Similarly, many people find themselves in situations where they are not able to strike up a conversation, such as when driving or jogging, yet wished that they could have talked with the other person. There are also many shy people out there that do not have the confidence to approach others and strike up a conversation.

In addition, today there are some ‘missed connections’ or ‘second chance encounters’ websites on the internet which try to reconnect people who have been in this situation, however, the problem with these existing sites is that neither person may know to go to that specific website to communicate at a later time.

### BRIEF SUMMARY OF THE INVENTION

The present invention provides a system for reconnecting individuals via a visual signal. The visual signal is used by a certain individual to indicate to another individual of interest to correspond with them at a certain pre-determined destination, such as a business location, or on-line via a computer network, such as the Internet or a destination website. Sending a visual signal to another individual indicates that a certain individual is interested in corresponding with the other individual for dating, friendship, or other social or professional networking.

### BRIEF DESCRIPTION OF THE SEVERAL VIEWS OF THE DRAWING

The accompanying drawing, which is incorporated into and constitutes a part of this specification, illustrates one or more embodiments of the present invention and, together with the detailed description, serve to explain the principles and implementations of the invention.

In the drawing:

FIG. 1 shows a flowchart illustrating a process of signaling individuals to reconnect at a destination website in accordance with one embodiment of the present invention.

### DETAILED DESCRIPTION OF THE INVENTION

Embodiments of the present invention are described herein in the context of a system, method, and apparatus for reconnecting individuals at a certain pre-determined destination such as a business location or a website via a visual signal. Reference will now be made in detail to implementations of the present invention as illustrated in the accompanying drawing. The same reference indicators will be used throughout the drawing and the following detailed description to refer to the same or like parts.

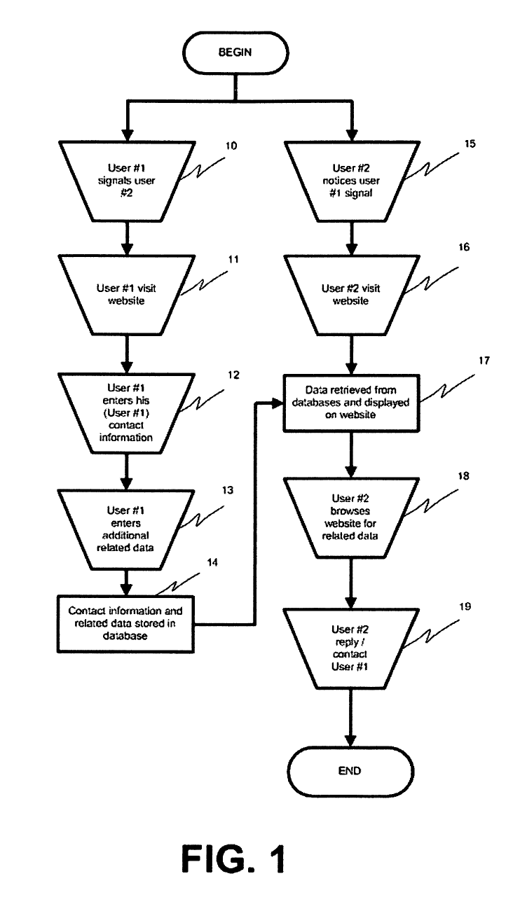

FIG. 1 illustrates the general methodology for utilizing the present invention. As shown in FIG. 1, person #1 indicates their interest to correspond with person #2 via a visual signal 10 to reconnect with person #2 15 at a destination website. The visual signal can be any visual signal including, but not limited to a facial gesture, a hand sign, or chin rub. At this point person #1 visits the destination website 11, and enters related information for reconnecting with person #2 12 & 13. At this point, the related information is stored in the destination website database 14. At the same time or at a later time, person #2 visits the destination website 16 which displays person #1's information by retrieving the data from the database 17. At this point person #2 can browse the website and exchange information with person #1 18 & 19.

The embodiments illustrated and discussed herein are intended only to teach those skilled in the art the best way known by the inventor to make and use the invention. Nothing in the specification should be considered as limiting the scope of the present invention. Changes could be made by those skilled in the art to produce equivalent methods without departing from the invention. The present invention should only be limited by the following claims and their legal equivalents.

What is claimed:

1. Methodology for reconnecting with people online via a visual signal, comprising the steps of:
a. Visually signaling a person of interest to indicate interest to reconnect on a destination website;
b. Visiting a destination website;
c. Entering and retrieving information on website for exchange of information;

2. The method of claim 1, wherein:
The visual signal is a gesture including, but not limited to, a facial gesture, a hand sign, or chin rub.

3. The method of claim 2, wherein:
The destination website includes, but is not limited to, a dating website, a social networking website, a business oriented website, a personal website, or a missed connections website where people exchange information.

4. The method of claim 3, wherein:
The destination website is used for business promoting purposes.

5. The method of claim 4, wherein:
The business promoting purposes include, but are not limited to, an advertising dedicated website, a sale of goods or commodities website or other retail website.

6. The method of claim 3, wherein:
The exchange of information includes, but is not limited to, personal description information, contact information, visual and/or audio information or requests for additional information

7. The method of claim 6, wherein:
The exchange of information includes, but is not limited to, images, video, music, text, or other media.

8. The method of claim 7, wherein:
The visual signal is composed of a sequence of two or more visual signals in a predetermined or random order.

9. Methodology for meeting with people at a pre-determined business location via a visual signal, comprising the steps of:
a. Visually signaling a person of interest to indicate interest to meet at a pre-determined business location;
b. Visiting a pre-determined business location;
c. Chatting and exchanging information at the pre-determined business location;

10. The method of claim 9, wherein:
The visual signal is a gesture including, but not limited to, a facial gesture, a hand sign, or chin rub.

11. The method of claim 10, wherein:
The pre-determined business location includes, but is not limited to, a restaurant, a bar or pub, a retail store, a museum, a public park or other public location.

12. The method of claim 11, wherein:
The visual signal is composed of a sequence of two or more visual signals.
